(19) United States
(12) Patent Application Publication
(10) Pub. No.: US 2005/0194307 A1
(43) Pub. Date: Sep. 8, 2005

(54) Ice sieve

(76) Inventor: Marty Fenyes, Huntington Beach, CA (US)

Correspondence Address: Marty (Marta) Fenyes, 7402 Seastar Drive #3, Huntington Beach, CA, 92648, US

(21) Appl. No.: 10/790,462

(22) Filed: Mar. 2, 2004

(51) Int. Cl. B01D 29/88

(52) U.S. Cl. 210/464; 210/248; 210/499

(57) ABSTRACT

The “Ice Sieve” is a simple device designed to give those who serve drinks (of any kind requiring ice) the ability to deliver only ice to a drinking vessel. In many instances, a bartender may not have the benefit of sink with a drain. In those instances, the bartender is usually supplied with only a bucket or large container with ice. As time passes the ice begins to melt resulting in unwanted dilution of the drinks attempted for preparation. The Ice Sieve offers a simple solution. As the ice is scooped it quickly drains back into the ice container allowing only the ice to be poured into the intended drinking vessel.

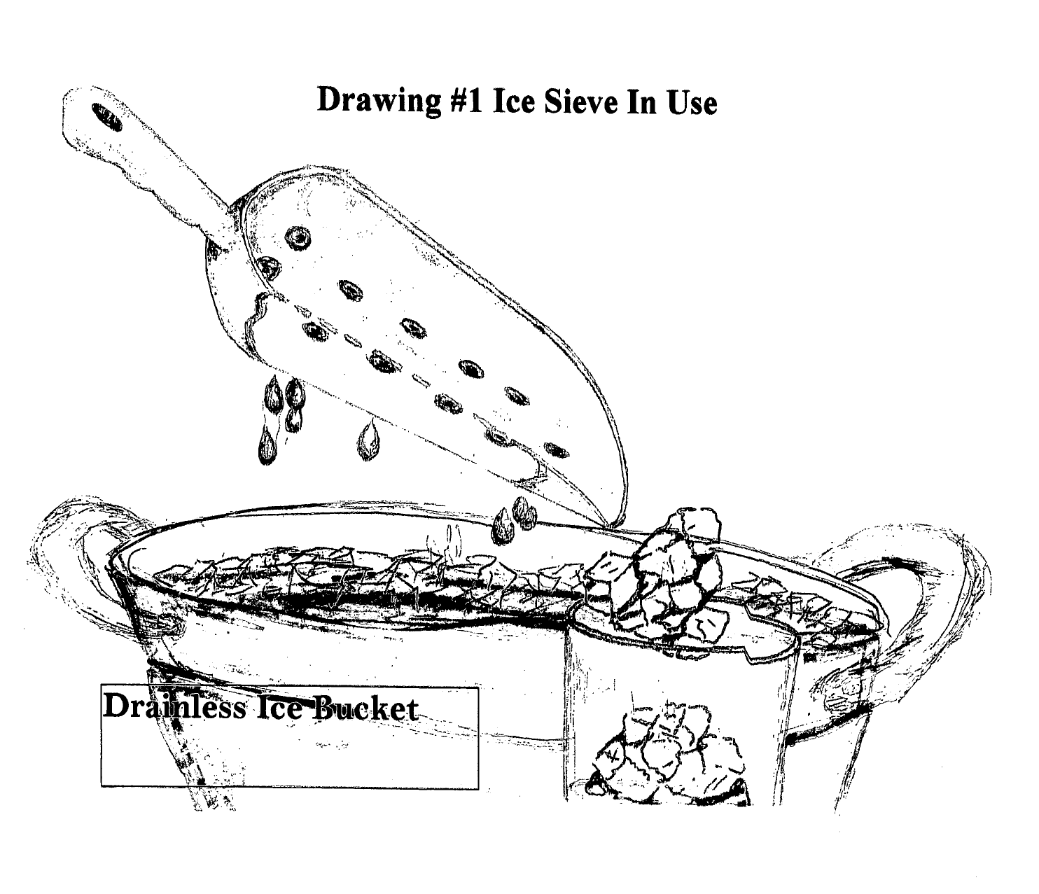

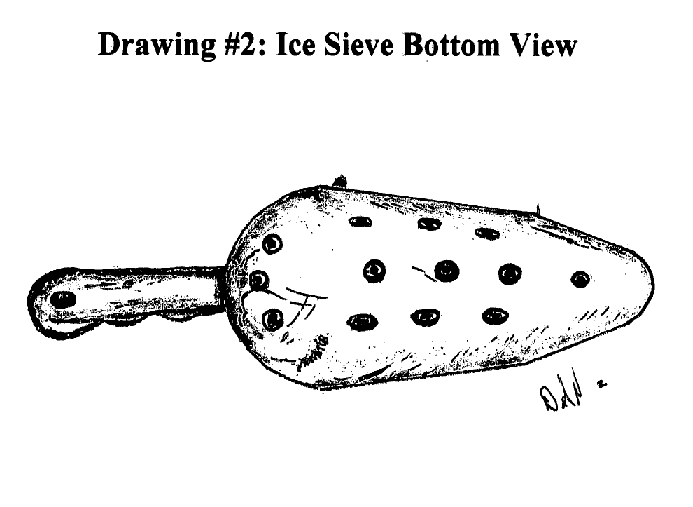

### CROSS REFERENCE TO RELATED APPLICATIONS

N/A

### STATEMENT REGARDING FED SPONSORED R & D

N/A

### REFERENCE TO SEQUENCE LISTING A TABLE OR A COMPUTER PROGRAM LISTING APPENDIX

N/A

### BACKGROUND OF INVENTION

The “Ice Sieve” is a modified metallic scoop, similar in appearance to those that may be used to scoop ice, flour, or sugar. The modifications to the standard scoop design is what differentiate and make the “Ice Sieve” unique and beneficial to various sectors of the bar tending industry.

Strategically placed countersunk perforations within the base of the scoop allow water from melting ice to quickly flow from the “Ice Sieve” and into the bucket or vessel the ice was scooped from, thereby avoiding the water from the melted ice from being poured into the beverage or cocktail the ice was destined for thus prevented a diluted beverage or cocktail.

Those bartenders who would benefit most greatly from the “Ice Sieve” are those who function as bartenders absent a sink with a drain. These bartenders usually serve at private functions or hotel suites utilizing portable bars. The ice is typically contained within a bucket without drainage.

The impetus behind the “Ice Sieve” came about due to my many years as a bartender. I've worked in a variety of bar atmospheres ranging from professional “built-ins” (restaurant type bars) to the more difficult portable Set-ups.

While working in a major hotel banquet department I realized that there was an overwhelming need for a device like the “ice Sieve” as it is common practice for major hotels and the like to set up portable bars and ice bins in various sectors of the hotel. Drainage in the aforementioned portable bar setups is virtually non-existent and after a short period of time the ice begins to melt leaving a tub of ice floating in water. Beverage pours became diluted while using a standard scoop. If the bar was exceptionally busy it became more and more difficult to separate the water from the ice thereby risking the satisfaction of patrons if they received what was perceived as a “watered down” drink.

The use of bare hands to strain the ice is potentially unsanitary as well as uncomfortable. Regrettably, the use of hands or watered down drinks is not an uncommon practice within the realm of the portable bars typically found in hotels, private banquets, or weddings.

The “Ice Sieve” is a modified scoop, designed to afford the bartender rapid drainage, comfort ability, as well as a sanitary means of serving beverages that utilize ice in the mix. This simple, yet innovative tool can replace the standard ice scoop while increasing efficiency and profitability by allowing beverages to be served much more quickly as the step of removing the water is eliminated from the drink making process under the portable bar circumstances as described above.

### SUMMARY OF THE INVENTION “THE ICE SIEVE”

The “Ice Sieve” is a modified metallic scoop with strategically situated countersunk, drilled holes. These holes allow water from an ice bucket or tub utilized by a bartender without drainage to quickly fill beverage glasses with ice only, i.e., allows water from the ice bucket to be drained off prior to filling a beverage glass destined for ice.

### DRAWINGS OF THE “ICE SIEVE”

Drawing 1: Depicts the top and side view of the “Ice Sieve”. Note the typical style scoop and the modified additions of the countersunk drill holes for water drainage.

Drawing 2: Depicts the underside of the “Ice Sieve” as well as a better view of the placement of the countersunk drill holes.

1. What I claim as my invention is: that Marty Fenyes is the inventor of the “ice sieve”. As such, this device as presented to the United States Patent and Trademark Office, does not exist as described within the (attached) Non Provisional Application. The Tool is designed to drain or dissipate water from ice intended for an elixir or mixed cocktail. The purpose is to prevent diluted mixed drinks and prevention of unsanitary introduction of bacteria to same. The “Ice Sieve” will provide the bartender (absent drainage) an efficient method of pouring drinks or beverages without contamination and excess water to patrons' drinks.
